(19) United States
(12) Patent Application Publication
(10) Pub. No.: US 2003/0232316 A1
(43) Pub. Date: Dec. 18, 2003

(54) Method and system of planning for and analyzing results of lessons incorporating standardized student learning objectives

(76) Inventor: Janis G. Bookout, Austin, TX (US)

Correspondence Address: Janis G. Bookout, 1403 Glencrest Drive, Austin, TX, 78723, US

(21) Appl. No.: 10/171,733

(22) Filed: Jun. 14, 2002

(51) Int. Cl. G09B 3/00

(52) U.S. Cl. 434/350; 434/362; 434/365; 434/169

(57) ABSTRACT

A method and system of planning for and analyzing results of lessons incorporating standardized student learning objectives which assists instructors and students in process of preparing for standardized tests while learning lessons. The present invention analyzes effectiveness of lessons covered as they are scored. The analysis feature of this invention allows a user to quickly and easily modify future lesson plans to assist students in learning required materials which will be tested during standardized testing. An instructor using the present invention can use personal teaching style and monitor effectiveness at any time during teaching period without relying solely on test-oriented lessons and practice tests. The present invention allows students and instructors increased confidence and reduced stress regarding whether all lessons will be adequately covered and incorporate requirements of standardized tests.

### BACKGROUND OF THE INVENTION

1. Field of the Invention

The present invention relates to a method and system of planning for and analyzing results of lessons incorporating standardized student learning objectives for use in connection with assisting instructors in preparing and assessing lessons that both meet students' learning needs and prepare them for standardized testing. The method and system of planning for and analyzing results of lessons incorporating standardized student learning objectives has particular utility in connection with giving teachers the ability to plan integrated lesson units or individual lessons while planning lessons based on standardized objectives while monitoring students' comprehension of lessons to allow for modifications to lesson plans when modifications are necessary as shown by lesson analysis feature of the present invention.

2. Description of the Prior Art

Methods of planning for and analyzing results of lessons incorporating standardized student learning objectives are desirable to assist instructors and students in covering all learning materials necessary to meet state-wide educational standards and standardized learning requirements.

The use of methods of planning for lessons is known in the prior art. For example, U.S. Pat. No. 6,135,662 to Bakke et al discloses a lesson planner that includes a foldable notebook containing a series of transparent lesson plan retaining sheets for supporting lesson planning card. However, the Bakke '662 patent does not incorporate standardized learning requirements, and has further drawbacks of not working with a computer and therefore being cumbersome.

U.S. Pat. No. 6,343,319 to Abensour et al discloses a method and system for curriculum delivery that comprises a capture, organization and delivery system. However, the Abensour '319 patent does not comprise a lesson planning system that incorporates standardized learning requirements, and additionally does not analyze student performance regarding requirements of standardized testing.

Similarly, U.S. Pat. No. 5,823,789 to Jay et al discloses a method and apparatus for correlating educational requirements that includes correlation of requirements of educators, guiding documents, and educational resource providers into a central database. However, the Jay '789 patent does not analyze student performance throughout school year, and can not reconfigure lesson plans based on student performance throughout school year.

Lastly, U.S. Pat. No. 5,864,869 to Doak et al discloses a method and manufacture of lesson plans and classroom organizers utilizing computers and software that creates and maintains an integrated classroom organizer using a computer. However, the Doak '869 patent does not incorporate requirements for standardized testing, and has the additional deficiency of not analyzing student performance to reconfigure lesson plans throughout school year. The Doak patent makes no provision for planning and revising lessons quickly and easily.

While the above-described devices fulfill their respective, particular objectives and requirements, the aforementioned patents do not describe a method and system of planning for and analyzing results of lessons incorporating standardized student learning objectives that allows planning lessons based on requirements for standardized learning while monitoring students' comprehension of lessons to allow for modifications to lesson plans when modifications are necessary as shown by lesson analysis feature of the present invention.

Therefore, a need exists for a new and improved method and system of planning for and analyzing results of lessons incorporating standardized student learning objectives that can be used for planning lessons based on standardized objectives while monitoring students' comprehension of lessons to allow for modifications to lesson plans when modifications are necessary as shown by lesson analysis feature of the present invention.

In this regard, the present invention substantially fulfills this need. In this respect, the method and system of planning for and analyzing results of lessons incorporating standardized student learning objectives according to the present invention substantially departs from the conventional concepts and designs of the prior art, and in doing so provides an apparatus primarily developed for the purpose of planning lessons based on requirements for standardized learning while monitoring students' comprehension of lessons to allow for modifications to lesson plans when modifications are necessary as shown by lesson analysis feature of the present invention.

### SUMMARY OF THE INVENTION

In view of the foregoing disadvantages inherent in the known types of methods and systems of planning for lessons incorporating standardized student learning objectives now present in the prior art, the present invention provides an improved method and system of planning for and analyzing results of lessons incorporating standardized student learning objectives, and overcomes the above-mentioned disadvantages and drawbacks of the prior art. “Lessons” as used herein is meant to refer to learning activity. “Activity” can also mean “lesson.” A “unit” as used herein is a set of lessons covering a set of subject areas, usually organized around a central theme or a time period.

As such, the general purpose of the present invention, which will be described subsequently in greater detail, is to provide a new and improved method and system of planning for and analyzing results of lessons incorporating standardized student learning objectives and method which has all the advantages of the prior art mentioned heretofore and many novel features that result in a method and system of planning for and analyzing results of lessons incorporating standardized student learning objectives which is not anticipated, rendered obvious, suggested, or even implied by the prior art, either alone or in any combination thereof.

To attain this, the present invention essentially comprises a method and system of planning for and analyzing results of lessons incorporating standardized student learning objectives comprising a computer program that plans lessons which incorporates standardized objectives, an analysis feature which analyzes student performance on requirements for standardized testing, and a feature which makes recommendations to user based on results from student performance analysis. The present invention includes a grade book feature which details each student's performance and performance of the class with regard to each standardized learning objective or requirement. This allows an instructor to modify future lesson plans for optimum comprehension of lessons by students.

There has thus been outlined, rather broadly, the more important features of the invention in order that the detailed description thereof that follows may be better understood and in order that the present contribution to the art may be better appreciated.

The invention may also include an activity bank which includes a list of activity ideas which may be sorted by subject, keyword or standardized learning objective. There are, of course, additional features of the invention that will be described hereinafter and which will form the subject matter of the claims attached.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved method and system of planning for and analyzing results of lessons incorporating standardized student learning objectives that has all of the advantages of the prior art methods and systems of planning for lessons and none of the disadvantages.

It is another object of the present invention to provide a new and improved method and system of planning for and analyzing results of lessons incorporating standardized student learning objectives that may be easily and efficiently manufactured and marketed.

An even further object of the present invention is to provide a new and improved method and system of planning for and analyzing results of lessons incorporating standardized student learning objectives that has a low cost of manufacture with regard to both materials and labor, and which accordingly is then susceptible of low prices of sale to the consuming public, thereby making such method and system of planning for and analyzing results of lessons incorporating standardized student learning objectives economically available to the buying public.

Still another object of the present invention is to provide a new method and system of planning for and analyzing results of lessons incorporating standardized student learning objectives that provides in the apparatuses and methods of the prior art some of the advantages thereof, while simultaneously overcoming some of the disadvantages normally associated therewith.

Even still another object of the present invention is to provide a method and system of planning for and analyzing results of lessons incorporating standardized student learning objectives for planning lessons based on requirements for standardized learning while monitoring students' comprehension of lessons to allow for modifications to lesson plans when modifications are necessary as shown by lesson analysis feature of the present invention.

This allows an instructor to modify future lesson plans for optimum comprehension of lessons by students. The present invention is quick and easy to use, while offering substantially increased results as compared to methods and systems currently in use for the same purpose. This inventor is unaware of a method or system that offers a user a quick and easy evaluation of lessons taught, a detailed analysis of student performance, and recommendations to user for construction of future lesson plans which can be composed within the present invention.

Lastly, it is an object of the present invention to provide a new and improved method and system of planning for and analyzing results of lessons incorporating standardized student learning objectives by choosing an option from a main menu; entering student information into computer program; checking activity bank for lesson plan ideas; planning lesson plan using lesson plan templates; building customized internet links; monitoring grade book option for analysis of lessons covered and for recommendations regarding lessons which should be covered; reviewing standardized learning objectives; and building new units with unit builder option.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a flowchart of the preferred embodiment of the method and system of planning for and analyzing results of lessons incorporating standardized student learning objectives constructed in accordance with the principles of the present invention.

FIG. 2 is a flowchart of the method and system of planning for and analyzing results of lessons incorporating standardized student learning objectives of the present invention.

FIG. 3 is a flowchart of the method and system of planning for and analyzing results of lessons incorporating standardized student learning objectives of the present invention.

FIG. 4 is a flowchart of the method and system of planning for and analyzing results of lessons incorporating standardized student learning objectives of the present invention.

FIG. 5 is a flowchart of the method and system of planning for and analyzing results of lessons incorporating standardized student learning objectives of the present invention.

FIG. 6 is a flowchart of the method and system of planning for and analyzing results of lessons incorporating standardized student learning objectives of the present invention.

FIG. 7 is a flowchart of the method and system of planning for and analyzing results of lessons incorporating standardized student learning objectives of the present invention.

FIG. 8 is a flowchart of the method and system of planning for and analyzing results of lessons incorporating standardized student learning objectives of the present invention.

FIG. 9 is a flowchart of the method and system of planning for and analyzing results of lessons incorporating standardized student learning objectives of the present invention.

The same reference numerals refer to the same parts throughout the various figures.

### DESCRIPTION OF THE PREFERRED EMBODIMENT

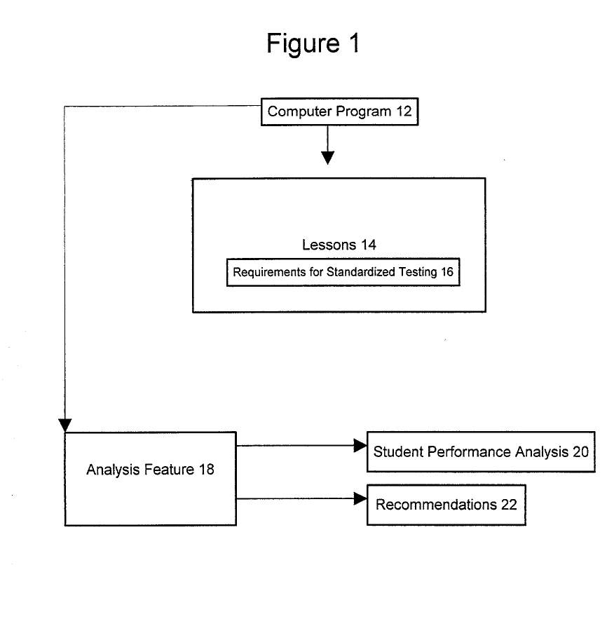

Referring now to the drawings, and particularly to FIGS. 1-9, a preferred embodiment of the method and system of planning for and analyzing results of lessons incorporating standardized student learning objectives of the present invention is shown and generally designated by the reference numeral 10.

In FIG. 1, a new and improved method and system of planning for and analyzing results of lessons incorporating standardized student learning objectives 10 of the present invention for planning lessons based on standardized objectives while monitoring students' comprehension of lessons to allow for modifications to lesson plans when modifications are necessary as shown by lesson analysis feature of the present invention is illustrated and will be described. “Lessons” as used herein is meant to refer to learning activity. “Activity” can also mean “lesson.” A “unit” as used herein is a set of lessons covering a set of subject areas, usually organized around a central theme or a time period.

More particularly, the method and system of planning for and analyzing results of lessons incorporating standardized student learning objectives 10 has a computer program 12 that plans lessons 14 which incorporates requirements for standardized learning 16. FIG. 1 also shows an analysis feature 18 which analyzes student performance 20 on requirements for standardized learning 16 and a feature which makes recommendations 22 to user based on results from student performance analysis 20.

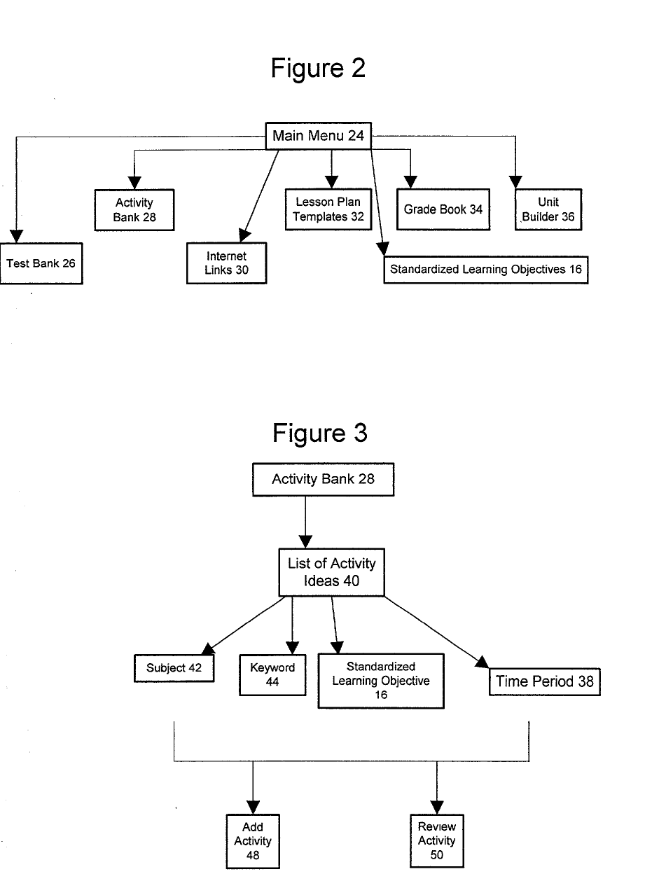

FIG. 2 shows a main menu 24 of computer program 12 includes at least one of a test bank 26, an activity bank 28, internet links 30, lesson plan templates 32, a grade book 34, standardized learned objectives 16, and a unit builder 36.

FIG. 3 shows the activity bank 28 which includes at least one of a list of activity ideas 40 sorted by subject 42, a list of activity ideas sorted by keyword 44, a list of activity ideas sorted by standardized learning objective 16, a list of activity ideas sorted by time period 38, an option to add activity 48, and an option to review activity 50.

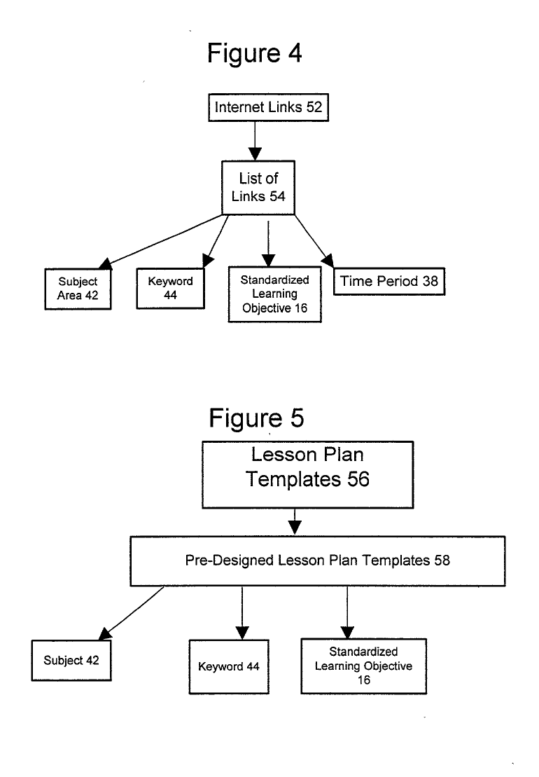

FIG. 4 shows the internet links 52 comprise at least one of a list of links 54 customized by user and sorted by subject area 42, keyword 44, standardized learning objective 16, or time period 38.

FIG. 5 shows the lesson plan templates 56 which open a list of pre-designed lesson plan templates 58 based on known lesson methods sorted by at least one of a subject area 42, a keyword 44, or a standardized learning objective 16.

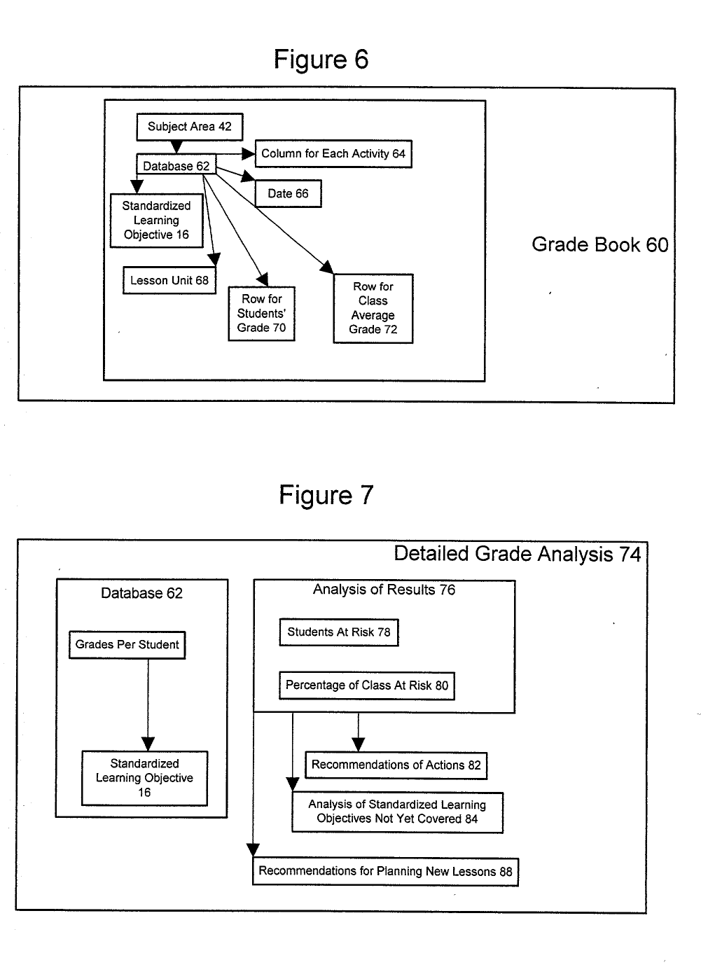

FIG. 6 shows the grade book 60 includes a section based on subject area 42 which connects with a database 62 to display at least one of a column for each activity 64, date 66, standardized learning objective 16, lesson unit 68 from which standardized learning objective 16 originated, one row for each students' grade 70, one row for class average grade 72.

FIG. 7 shows a detailed grade analysis 74 which includes a database 62 of grades per student per standardized learning objective 16. FIG. 7 also shows an analysis of results 76 based on pre-set parameters by standardized learning objective 16, such as students at risk who have low grades 78, and percentage of class at risk 80. FIG. 7 shows the present invention's feature of recommendations of actions 82 for user to take based on analysis of results 76. FIG. 7 shows an analysis of standardized learned objectives not yet covered 84. FIG. 7 also shows recommendations to user to revisit certain standardized learned objectives 88 linked to lessons in which student class average grades were below a certain percentage. FIG. 7 features recommendations to user for planning new lessons 88 for any standardized learning objective 16 that has been covered in less than a certain amount of lessons programmed into database 62 by user. The database 62 makes recommendations for planning future lessons 88 based on analysis of students' performance and future planned lessons. For example, if student class average grades are below a certain percentage for a particular lesson and the same lesson is planned for future lessons to be covered, the recommendations will not recommend to the user to add the particular lesson to future lessons. This feature reduces risk of unnecessary redundancy in lessons covered.

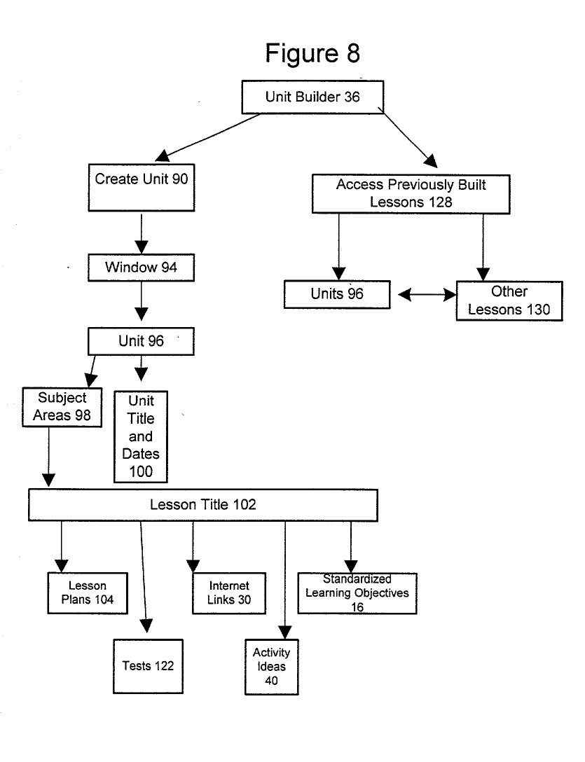

FIG. 8 shows a unit builder 36 which includes an option for a user to create a new unit 90 which comprises a window 94 with a unit 96 which shows all major subject areas as column heads 98; an option to enter unit title and start and end dates 100; an option to enter title of lesson 102; and a selection of at least one of lesson plans 104, tests 122, internet links 30, activity ideas 40, and standardized learning objectives 16. Standardized learned objectives 16 can be automatically attached to at least one of the lesson plans 104, tests 122, internet links 30, and activity ideas 40. FIG. 8 also shows the user can access previously built lessons 128 from the unit builder 36, which can be in the form of units 96 or other lessons 130.

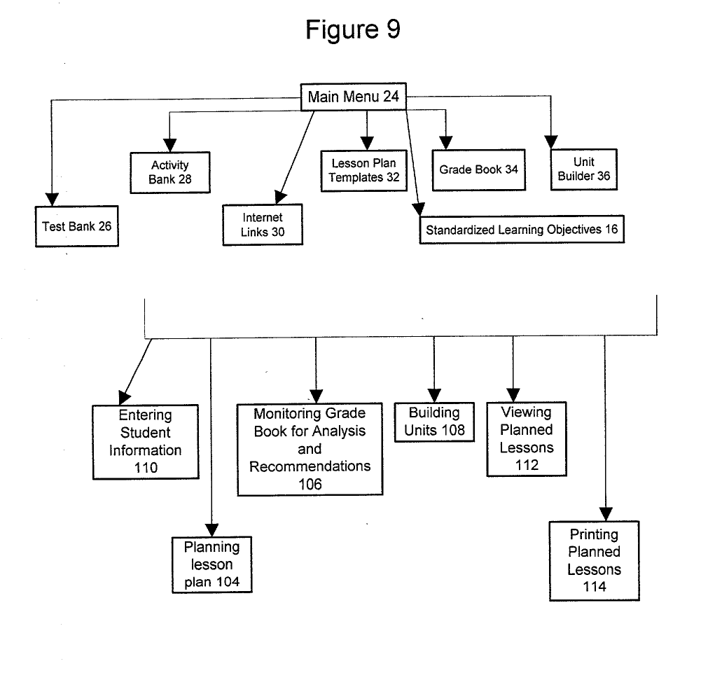

FIG. 9 illustrates a method and system of planning for and analyzing results of lessons incorporating requirements for standardized student learning 10 by choosing an option from a main menu 24; and entering student information 110. The present invention also includes options of checking activity bank 28 for lesson plan ideas; planning lesson plan 104 using lesson plan templates 32; building customized internet links 30; monitoring grade book option 106 for analysis of lessons covered and for recommendations regarding lessons which should be covered; reviewing standardized learning objective 16; building new units 108 with unit builder 36 option, viewing planned lessons 112, and printing planned lessons 114.

In use, it can now be understood that method and system of planning for and analyzing results of lessons incorporating standardized student learning objectives is necessary in assisting students and instructors to meet standardized learned objectives while learning lessons planned.

While a preferred embodiment of the method and system of planning for and analyzing results of lessons incorporating standardized student learning objectives has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. For example, any suitable computer software program may be used instead of the computer program described. Also, the features on the main menu can be expanded to include additional related features. And although planning lessons based on standardized objectives while monitoring students' comprehension of lessons to allow for modifications to lesson plans when modifications are necessary as shown by lesson analysis feature of the present invention have been described, it should be appreciated that the method and system of planning for and analyzing results of lessons incorporating standardized student learning objectives herein described is also suitable for functioning as a grade book. Furthermore, a wide variety of grade book features may be used in addition to those described.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method and system of planning for and analyzing results of lessons incorporating standardized student learning objectives comprising:
a computer program that plans lessons which incorporates standardized objectives;
an analysis feature which analyzes student performance on standardized objectives; and
a feature which makes recommendations to user based on results from student performance analysis and database information.

2. The method and system of planning for and analyzing results of lessons incorporating standardized student learning objectives of claim 1 wherein a main menu of computer program includes at least one of a test bank, an activity bank, internet links, lesson plan templates, a grade book, standardized learning requirements, and a unit builder.

3. The method and system of planning for and analyzing results of lessons incorporating standardized student learning objectives of claim 2 wherein the activity bank includes at least one of a list of activity ideas sorted by subject, a list of activity ideas sorted by keyword, a list of activity ideas sorted by standardized learning objective, a list of activity ideas sorted by time period, an option to add activity, and an option to review activity.

4. The method and system of planning for and analyzing results of lessons incorporating standardized student learning objectives of claim 2 wherein the internet links comprises at least one of a list of links customized by user and sorted by subject area, keyword, time period, or standardized learning objective.

5. The method and system of planning for and analyzing results of lessons incorporating standardized student learning objectives of claim 2 wherein the lesson plan templates opens a list of pre-designed lesson plan templates based on known lesson methods sorted by at least one of a subject area, a keyword, or a standardized learning objective.

6. The method and system of planning for and analyzing results of lessons incorporating standardized student learning objectives of claim 2 wherein the grade book includes a section based on subject area which connects with a database to display at least one of a column for each activity, date, related standardized learning objective, lesson unit from which standardized learning objective originated, one row for each student's grade, one row for class average grade.

7. The method and system of planning for and analyzing results of lessons incorporating standardized student learning objectives of claim 6 further comprising a detailed grade analysis which includes a database of grades per student per standardized learning objective.

8. The method and system of planning for and analyzing results of lessons incorporating standardized student learning objectives of claim 7 further comprising an analysis of results based on pre-set parameters by standardized learning objective, such as students at risk who have a low grade average, and percentage of class at risk.

9. The method and system of planning for and analyzing results of lessons incorporating standardized student learning objectives of claim 8 further comprising recommendations of actions for user to take based on analysis of results.

10. The method and system of planning for and analyzing results of lessons incorporating standardized student learning objectives of claim 8 further comprising analysis of standardized learned objectives not yet covered.

11. The method and system of planning for and analyzing results of lessons incorporating standardized student learning objectives of claim 8 further comprising recommendations of lessons to plan based on analysis of students' performance and future planned lessons.

12. The method and system of planning for and analyzing results of lessons incorporating standardized student learning objectives of claim 8 further comprising recommendations to user to revisit certain standardized learned objectives linked to lessons in which student class average grades were below a certain percentage.

13. The method and system of planning for and analyzing results of lessons incorporating standardized student learning objectives of claim 8 further comprising recommendations to user for planning new lessons for any standardized learning objective that has been covered in less than a pre-set number of lessons.

14. The method and system of planning for and analyzing results of lessons incorporating standardized student learning objectives of claim 2 wherein the standardized learning objective section comprises a list of pertinent standardized learning objectives wherein tested items are highlighted.

15. The method and system of planning for and analyzing results of lessons incorporating standardized student learning objectives of claim 2 wherein the unit builder includes an option for a user to build a new unit which comprises:
a window with a table which shows all major subject areas as column heads;
an option to enter unit title and start and end dates;
an option to enter title of activity; and
a selection of at least one of lesson plans, tests, internet links, activity ideas, and standardized learned objectives.

16. The method and system of planning for and analyzing results of lessons incorporating standardized student learning objectives of claim 15 wherein standardized learned objectives are automatically attached to at least one of the lesson plans, tests, internet links, and activity ideas.

17. The method and system of planning for and analyzing results of lessons incorporating standardized student learning objectives of claim 2 wherein the unit builder includes an option to access previously built lessons and units.

18. A method and system of planning for and analyzing results of lessons incorporating standardized student learning objectives comprising the steps of:
choosing an option from a main menu;
entering student information into database;
checking activity bank for lesson plan ideas;
planning lesson plan using lesson plan templates;
building customized internet links;
reviewing standardized learning objectives;
building new units with unit builder option; and
viewing planned lessons which are operable to be printed.

19. The method and system of planning for and analyzing results of lessons incorporating standardized student learning objectives of claim 18 further comprising the step of:
viewing planned lessons which are operable to be printed which comprise a list of standardized learning objectives met and a list of standardized learning objectives to be met.

20. The method and system of planning for and analyzing results of lessons incorporating standardized student learning objectives of claim 18 further comprising the steps of:
monitoring grade book option for analysis of lessons covered and for recommendations regarding lessons which should be covered;
reviewing standardized learning objectives; and
building new units with unit builder option.
